(19) United States
(12) Patent Application Publication
(10) Pub. No.: US 2006/0002653 A1
(43) Pub. Date: Jan. 5, 2006

(54) Apparatus for an optical circuit having a flat wavelength response

(76) Inventors: Anders Grunnet-Jepsen, San Jose, CA (US); John N. Sweetser, San Jose, CA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/881,431

(22) Filed: Jun. 30, 2004

(51) Int. Cl. G02B 6/26; G02B 6/42

(52) U.S. Cl. 385/16; 385/31; 385/27; 385/39; 385/37; 385/42; 385/48; 385/5

(57) ABSTRACT

Optical circuits having a flat wavelength response are disclosed. A disclosed apparatus includes a first optical coupler, first and second optical waveguides optically coupled to the first optical coupler and a second optical coupler optically coupled to the first and second optical waveguides. The first optical coupler couples input light into a first portion and a second portion. The first and second optical waveguides receive the first and second portions of input light from the first optical coupler, respectively the second optical coupler couples the first portion of input light from the first optical waveguide and the second portion of input light from the second optical waveguide. The second optical waveguide may effect a fixed phase difference of one-half wavelength relative to the input light. The first and second optical couplers may have first and second wavelength dependences, respectively, where the second wavelength dependence is opposite the first wavelength dependence.

### FIELD OF THE TECHNOLOGY

The application relates generally to Mach-Zehnder interferometer based planar lightwave circuits, and, more particularly, to planar integrated optical add/drop multiplexers with a flat wavelength response.

### BACKGROUND

Many planar lightwave circuits are designed to have as flat a wavelength response as possible. That is, the optical circuit does not vary its response based on the wavelength of the optical signal. For example, a Mach-Zehnder Interferometer (MZI) based Optical Add-Drop Multiplexer (OADM) using Bragg gratings receives a multiplexed optical signal having multiple wavelengths or multiple wavelength channels. The OADM adds (multiplexes) and drops (demultiplexes) different wavelengths or channels from the optical signal. A 50/50 differential coupler couples the input light to two arms of the interferometer, each arm having a grating tuned to a resonant wavelength, otherwise known as the wavelength to be dropped. The gratings in each arm reflect and separate that wavelength from the optical signal. The reflected wavelength is coupled via constructive interference to a drop port which is coupled to the first coupler. The remaining wavelengths are transmitted to another 50/50 differential coupler and outputted to a cross state output via constructive interference. Additional light of the dropped wavelength is provided via an add port (corresponding to a bar state output) coupled to the second coupler and reflected by the gratings out the cross state output.

A balanced MZI was used for the MZI-based OADM, in which the optical path lengths of each arm were equalized to provide no effective optical path length difference. UV trimming was sometimes used in one of the arms before the grating to attenuate the dropped wavelength. In effect, the OADM was intended to drop only the resonant wavelength, without affecting the remaining wavelengths, thereby minimizing signal dB loss and signal degradation. However, although the 50/50 differential couplers could couple or split a particular wavelength according to a 50:50 ratio, the couplers were often wavelength dependent. For example, a coupler would couple a first wavelength according to the 50:50 ratio, but couple a second wavelength according to a 49:51 ratio. This resulted in band-narrowing of the OADM output which resulted in strong insertion loss variations across the optical bandwidth. Generally, band-narrowing is to be avoided in optical communications having a multiplexed optical signal, such as the conventional band (1530-1565 nm) and the long band (1570-1600 nm). Although the signal loss in a single OADM is minimal and generally acceptable, this signal loss was accentuated when multiple, cascaded OADMs were used to (de)multiplex multiple wavelengths. Due to the resultant wavelength response of each OADM, some wavelength channels experienced more signal loss than others.

While some signal loss may be unavoidable, the signal loss should be uniform across the output bandwidth. While attempts have been made to manufacture broadband couplers having little or no wavelength dependence, otherwise referred to as having a flat wavelength response, such couplers are often very long and difficult to realize in practice due to difficulties in manufacturing and use. However, in practice, even broadband couplers rarely had a perfect coupling ratio with no wavelength dependence. Generally, this was due to manufacturing defects, variations in substrate temperature, imperfect glass density and lack of uniformity, for example. Both couplers used in an MZI-based OADM were generally made in the same manufacturing process, which may include the same materials batch or the same processing batch, for example, and thereby had the same defects. In effect, the couplers were nominally identical and exhibited the same wavelength dependences. In addition to OADMs, thermo-optic switches and variable optical attenuators also utilized Mach-Zehnder interferometers with wavelength dependent couplers, and experienced the same wavelength response and band-narrowing issues mentioned with respect to the OADM.

### BRIEF DESCRIPTION OF THE DRAWINGS

FIG. 1 is a schematic diagram illustrating an example of a broadband Mach-Zehnder based optical add/drop multiplexer;

FIG. 2 is schematic diagram illustrating a one-half wavelength effective path length difference in an arm of the optical add/drop multiplexer of FIG. 1;

FIG. 3 is schematic diagram illustrating a multiple wavelength optical add/drop multiplexer using cascaded optical add/drop multiplexers of FIG. 1;

FIG. 4 is a schematic diagram illustrating a second example of a broadband Mach-Zehnder based optical add/drop multiplexer;

FIG. 5 is schematic diagram illustrating a first optical coupler of the optical add/drop multiplexer of FIG. 4;

FIG. 6 is schematic diagram illustrating a second optical coupler of the optical add/drop multiplexer of FIG. 4;

FIG. 7 is schematic diagram illustrating a multiple wavelength optical add/drop multiplexer using cascaded optical add/drop multiplexers of FIG. 4;

FIG. 8 is a chart illustrating the bar state output of the optical add/drop multiplexer of FIG. 1;

FIG. 9 is a chart illustrating the cross state output of the optical add/drop multiplexer of FIG. 1;

FIG. 10 is a chart illustrating the bar state output of the optical add/drop multiplexer of FIG. 4;

FIG. 11 is a chart illustrating the cross state output of the optical add/drop multiplexer of FIG. 4;

FIG. 12 is a schematic diagram illustrating an example of a broadband Mach-Zehnder based thermo optic switch; and

FIG. 13 is a schematic diagram illustrating an example of an optical system incorporating an optical add/drop multiplexer and a thermo-optic switch.

### DETAILED DESCRIPTION OF THE EXAMPLES

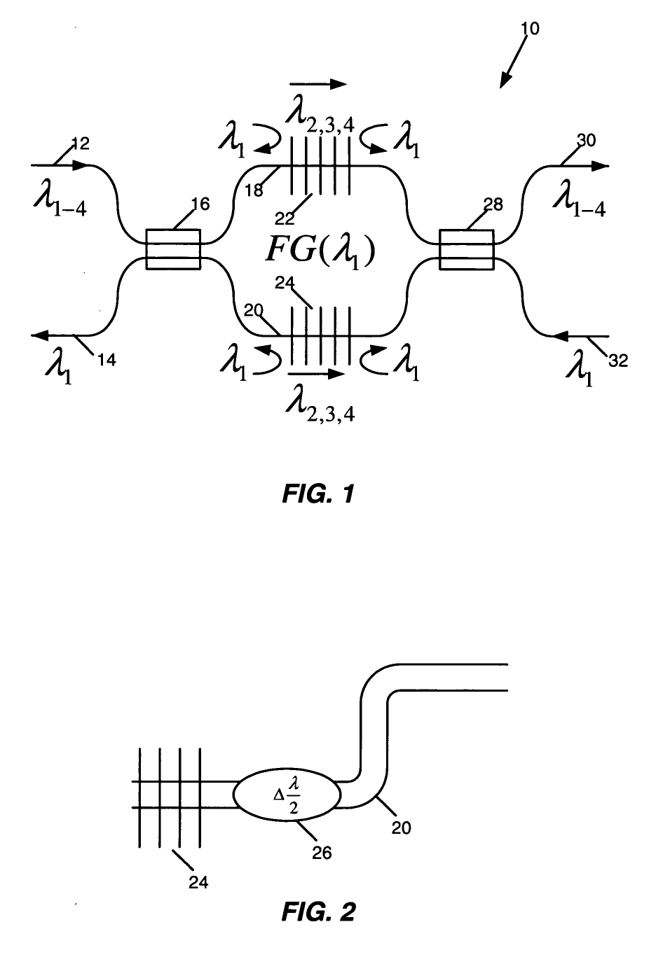

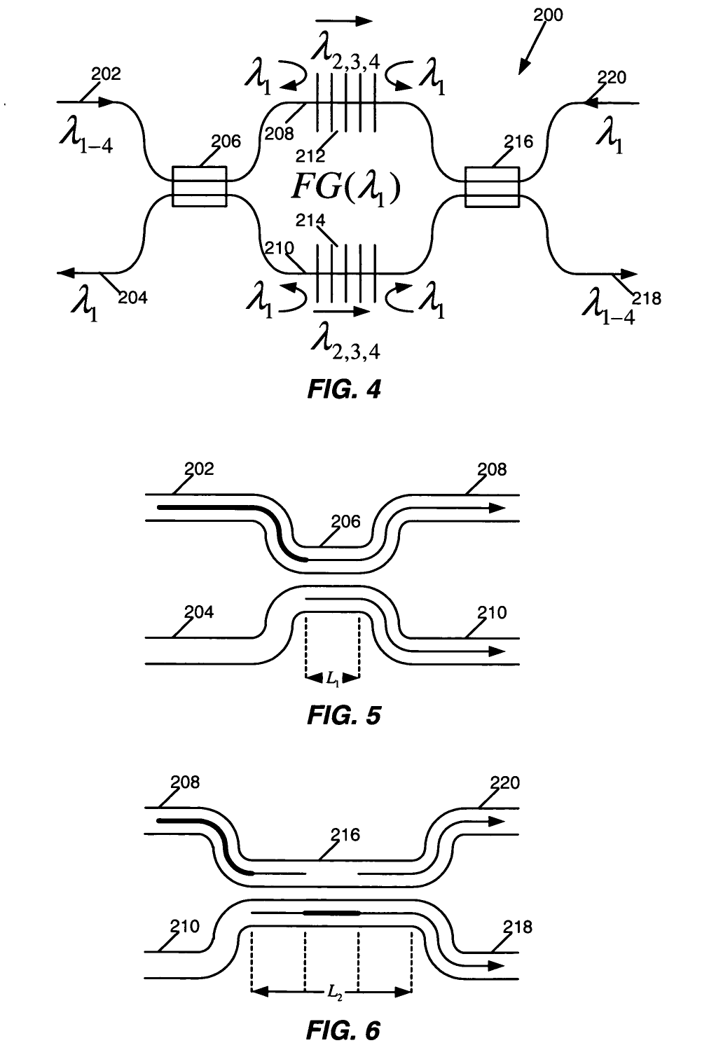

Examples of an optical circuits having a flat wavelength response are shown generally in FIGS. 1 and 4. Although the optical circuits are particularly well suited for optical add/drop multiplexers, or the like, the teachings of the instant patent are not limited to any particular type of optical circuit. On the contrary, the teachings of the patent can be employed with virtually any optical circuit, including planar lightwave circuits. Thus, although the optical circuit will be described below primarily in relation to an optical add/drop multiplexer, the apparatus could likewise be used with optical switches such as broadband thermo-optic switches, variable optical attenuators and various combinations involving the above-mentioned optical circuits such as reconfigurable optical add/drop multiplexers.

Referring to FIG. 1, an optical add/drop multiplexer 10 may be provided as an optical circuit, such as a planar lightwave circuit. The optical add/drop multiplexer 10 is based on a Mach-Zehnder interferometer, which includes an input port 12 and a drop port 14 each optically coupled to a first optical coupler 16. The input port 12, the drop port 14 and the optical coupler 16 may be provided as waveguides disposed on a substrate. Input light from a light source, as indicated by the arrow labeled λ₁₋₄ superimposed on the input port 16, is coupled via the input port 12 to the optical coupler 16. The input light λ₁₋₄ may be a multiplexed signal from a fiber optic transmission or a laser. A multiplexed signal may include input light having multiple wavelengths, or multiple wavelength channels each of which may include a wavelength bandwidth of one or more wavelengths. Although described herein as multiple wavelengths (λ₁, λ₂, λ₃, λ₄), it should be understood that the following description may refer to multiple wavelength channels as well.

The optical coupler 16 is a directional coupler which splits the input light into first and second portions according to a coupling phase or ratio. As such, although referred to as an optical coupler, the optical coupler 16 is a coupler/splitter. In one example, the optical coupler 16 is a 50/50 wavelength dependent coupler such that different wavelengths are split into first and second portions according to different phases or ratios. For instance, the optical coupler 16 may couple a first wavelength λ₁ at equally distributed at a 50:50 ratio and couple a second wavelength λ₂ at a 49:51 ratio. The optical coupler 16 may include two waveguides with one waveguide optically coupled to the input port 12 and the other waveguide optically coupled to the drop port 14. The two waveguides are positioned proximate to each other to cause evanescent coupling between the waveguides. However, different optical couplers, including fused waveguide couplers, may be utilized.

The optical coupler 16 is optically coupled to an upper arm 18 and a lower arm 20 of the interferometer. The upper and lower arms 18, 20 may be provided as waveguides disposed on the substrate similar to the input port 12, the drop port 14 and the optical coupler 16. One portion of the input light is coupled to the upper arm 18 and a second portion of the input light is coupled to the lower arm 20 according to the coupling ratio of the optical coupler 16. Each of the input light portions may include the multiple wavelengths λ₁₋₄ as provided in the input light, though, as mentioned, the coupling ratio may vary among the various wavelengths.

The upper and lower arms 18, 20 are provided as optical waveguides, each having an optical path length. The upper arm 18 receives one portion of the input light from the optical coupler 16, and the lower arm 20 receives the other portion of the input light from the optical coupler 16. Each arm 18, 20 also includes a grating 22, 24, such as a Fiber Bragg grating (FG), each of which has a reflective resonance tuned to reflect a particular wavelength λ₁ and transmit the remaining wavelengths λ₂₋₄ with little or no effect on the remaining wavelengths λ_{2,3,4}. Different gratings or methods of selecting particular wavelengths may also be used in place of the gratings 22, 24. The gratings 22, 24 may also be disposed on the substrate, and may be provided by modifying the upper and lower arm waveguides 18, 20.

As each portion of input light is incident on the gratings 22, 24, the resonant wavelength λ₁ is reflected back to the optical coupler 16 and coupled in the optical coupler 16. As light is cross-coupled through the coupler 16, which includes light coupled from the input port 12 to the lower arm 20 or from the upper arm 18 to the drop port 14, the light undergoes a 90° (π/2) phase shift. As such, there is a 180° (π) phase difference between the two portions of the reflected wavelength λ₁ at the input port 12, resulting in destructive interference. Conversely, there is no phase difference between the two portions of the reflected wavelength λ₁ at the drop port 14, resulting in constructive interference. The reflected wavelength λ₁ is thereby reflected out the drop port 14 and not the input port 12, and separated from the transmitted wavelengths λ_{2,3,4}.

The remaining wavelengths in each portion of the input light are propagated through the arms 18, 20 of the interferometer. The light through the upper arm 18 propagates through a first optical path length and the light through the lower arm 20 propagates through a second optical path length. Referring to FIG. 2, the upper and lower arms 18, 20 have an effective path length difference of one-half wavelength (λ/2) to cause a phase difference of 180° (π) between the two portions of the transmitted wavelengths λ_{2,3,4}. As such, the transmitted wavelengths λ_{2,3,4} in the lower arm 20 have a one-half wavelength differential relative to the input light and the transmitted light in the upper arm 18. The actual path length difference may be greater than one-half wavelength, though the transmitted wavelengths λ_{2,3,4} experience the same effective path length difference. The path length difference may be provided in various ways, including ultraviolet trimming. Alternatively, the effective path length difference may be accomplished by additional methods of varying the refractive index, including thermal or voltage applications, or by varying the width of the waveguide. The interferometer is thereby an unbalanced interferometer.

As shown in FIG. 2, the effective path length difference is applied to the lower arm 20 after the grating 24. However, the effective path length difference may be applied in the upper arm 18 and may be applied either before or after the gratings 22, 24. In one example, the upper arm 18 may be provided with UV trimming before the grating 22 and the lower arm 20 may be provided with UV trimming after the grating 24, or vice versa. While the UV trimming in the lower arm 20 may be used to provide the one-half wavelength effective path length difference, the UV trimming in the upper arm 18 before the grating 22 may be provided to attenuate or switch the dropped wavelength λ₁.

Referring again to FIG. 1, the upper arm 18 and the lower arm 20 are optically coupled to an optical coupler 28. The optical coupler 28 is similar to the optical coupler 16, in that the optical coupled 28 is a directional coupler/splitter having the same wavelength dependence and coupling ratio as the optical coupler 16. The optical coupler 28 may also be a 50/50 evanescent coupler or a fused waveguide coupler, and the coupling ratio may vary depending on the wavelength. For example, the coupling ratio may be 50:50 at wavelength λ₁ and 49:51 at wavelength λ₂. In one example, the optical couplers 16, 28 are nominally identical and may be formed from the same material and in the same manufacturing process. The transmitted wavelengths λ_{2,3,4} in the upper arm 18 and the lower arm 20 are coupled to the optical coupler 28 with a phase difference of 180° (π).

The optical coupler 28 is optically coupled to an output port 30 and an add port 32. The optical coupler 28, the output port 30 and the add port 32 may each be provided as waveguides disposed on the substrate, similar to the other elements 12, 14, 15, 18, 20, 22, 24. The transmitted wavelengths λ_{2,3,4} that are cross-coupled through the optical coupler 28, which includes light coupled from the lower arm 20 to the output port 30 or from the upper arm 18 to the add port 32, undergo a 90° (π/2) phase shift. Due to the 90° (π/2) phase shift from cross-coupling in the optical coupler 16, the 180° (π) phase differential in the lower arm 20 and the 90° (π/2) phase shift from cross-coupling in the optical coupler 28, the transmitted wavelengths λ_{2,3,4} from the lower arm 20 interfere constructively with the transmitted wavelengths λ_{2,3,4} from the upper arm 18 (which undergo no phase shift) at the output port 30. Conversely, there is a 180° (π) phase difference between the two portions of the transmitted wavelengths λ_{2,3,4} at the add port 32, resulting in destructive interference.

Light of the same wavelength as the dropped wavelength λ₁ is input to the add port 32 and coupled to the optical coupler 28. The optical coupler 28 couples a portion of the added wavelength λ₁ to the upper arm 18 and another portion to the lower arm 20 according to the coupling ratio of the optical coupler 28. Each portion of added wavelength λ₁ is incident on the gratings 22, 24 and, as the resonant wavelength, the added wavelength λ₁ is reflected back to the optical coupler 28. As the added wavelength λ₁ is cross-coupled through the coupler 28, which includes light coupled from the add port 32 to the upper arm 18 or from the lower arm 20 to the output port 30, the added wavelength λ₁ undergoes a 90° (π/2) phase shift. As such, there is a 180° (π) phase difference between the two portions of the added wavelength λ₁ at the add port 32, resulting in destructive interference. Conversely, there is no phase difference between the two portions of the added wavelength λ₁ at the output port 30, resulting in constructive interference. Light of the same wavelengths λ₁₋₄ as the input light is thereby transmitted out the output port 30 which corresponds to a bar state port, and the add port 32 corresponds to a cross state port. By providing the output port as the bar state port, the various wavelengths λ₁₋₄ may be multiplexed and demultiplexed independent of the wavelength dependence of the optical couplers 16, 28. The optical add/drop multiplexer 10 may thereby provide a flat wavelength response in the output.

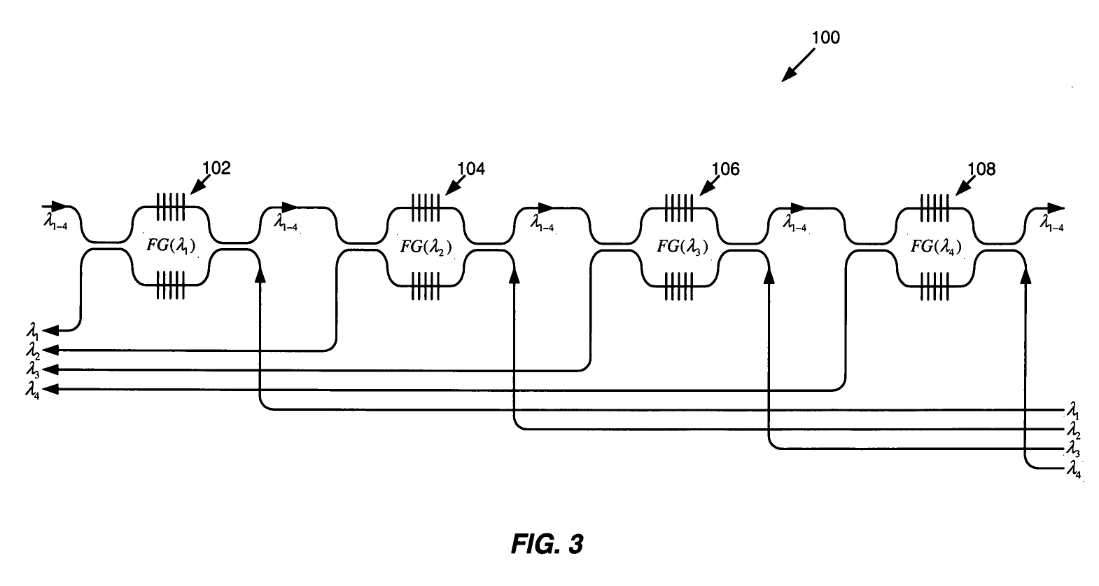

Referring to FIG. 3, a multiple wavelength optical add/drop multiplexer 100 is shown which includes multiple optical add/drop multiplexers 102, 104, 106, 108 as described with respect to FIG. 1. The add/drop multiplexers 102, 104, 106, 108 may be provided on the same substrate, and the multiple wavelength optical add/drop multiplexer 100 may be provided as a planar lightwave circuit. Each add/drop multiplexer 102, 104, 106, 108 may include gratings having different reflective resonances tuned to reflect a different wavelength and transmit the remaining wavelengths with little or no effect on the remaining wavelengths. The output port of each optical add/drop multiplexer 102, 104, 106, 108 may be optically coupled to the input port of the next optical add/drop multiplexer, providing a cascaded arrangement of the optical add/drop multiplexers 102, 104, 106, 108.

Each optical add/drop multiplexer 102, 104, 106, 108 may thereby drop a different wavelength, and the multiple wavelength optical add/drop multiplexer 100 may be used to multiplex and demultiplex various wavelengths within a multiplexed optical signal. For example the first optical add/drop multiplexer 102 may drop wavelength λ₁, the second optical add/drop multiplexer 104 may drop wavelength λ₂, the third optical add/drop multiplexer 106 may drop wavelength λ₃, and the fourth optical add/drop multiplexer 102 may drop wavelength λ₄. The number of optical add/drop multiplexers may depend on the number of wavelengths in the input light signal, or on the number of wavelengths to be dropped. Because each optical add/drop multiplexer 102, 104, 106, 108 operates independently of the wavelength dependence of the optical couplers, the multiple wavelength optical add/drop multiplexer 100 may provide an output signal without band-narrowing, and with an even wavelength response.

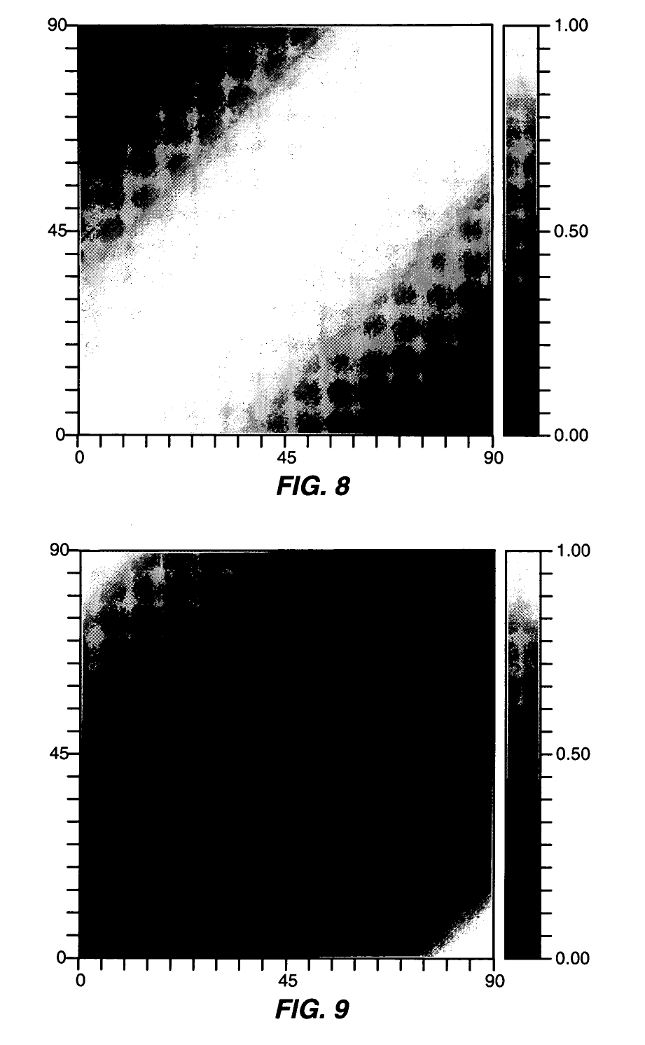

FIGS. 8 and 9 correspond to the output to the bar state (the output port 30) and the output to the cross state (the add port 32), respectively. The Y-axis in each of FIGS. 8 and 9 corresponds to the wavelength dependence of the first optical coupler 16, and the X-axis in each of FIGS. 8 and 9 corresponds to the wavelength dependence of the second optical coupler 28. The wavelength dependence of each optical coupler 16, 28 is shown as the coupling ratio, or coupling phase, of each optical coupler 16, 28. The grayscale of FIGS. 8 and 9 correspond to the intensity of the light being transmitted out the output port 30 and the add port 32, respectively.

As shown in FIG. 8, if the optical couplers 16, 28 have substantially the same wavelength dependence, all of the light is output through the bar state port (the output port 30). Because the optical couplers 16, 28 are generally manufactured in the same process, which may include the same batch of materials or the same manufacturing batch, for example, the optical couplers 16, 28 will generally be nominally identical and have the same imperfections. As such, as the coupling ratios may vary depending on wavelength, the optical couplers 16, 28 experience the same wavelength dependence. As seen in FIG. 8, if the coupling ratios of the optical couplers 16, 28 are substantially the same, all light will be output through the output port 30 even if the coupling phase vary from zero degrees (100:0) to 90 degrees (0:100). Likewise, if the coupling ratios of the optical couplers 16, 28 are substantially the same, no light is transmitted through the add port 32, as seen in FIG. 9.

Referring to FIG. 4, another example of an optical add/drop multiplexer 200 is shown. As with the optical add/drop multiplexer 10 above, the optical add/drop multiplexer 200 may be provided as an optical circuit, such as a planar lightwave circuit, based on a Mach-Zehnder interferometer. The optical add/drop multiplexer 200 includes an input port 202 and a drop port 204 each optically coupled to a first optical coupler 206, and each of which may be disposed on a substrate. Input light, which may be a multiplexed optical signal having multiple wavelengths λ₁₋₄ is coupled via the input port 202 to the optical coupler 206.

The optical coupler 206 is a directional coupler/splitter which splits the input light into first and second portions according to its coupling phase or ratio. The optical coupler 206 may have a wavelength dependence resulting in different coupling phases or ratios for different wavelengths. The optical coupler 206 may include two waveguides with one waveguide optically coupled to the input port 202 and the other waveguide optically coupled to the drop port 204. The two waveguides are positioned proximate to each other to cause evanescent coupling between the waveguides, though fused waveguide couplers may be utilized.

The optical coupler 206 is optically coupled to an upper arm 208 and a lower arm 210 of the interferometer. The upper and lower arms 208, 210 may be provided as waveguides disposed on the same substrate as the input port 202, the drop port 204 and the optical coupler 206. One portion of the input light is coupled to the upper arm 208 and a second portion of the input light is coupled to the lower arm 210 according to the coupling ratio of the optical coupler 206.

As with the optical add/drop multiplexer 10 above, the upper arm 208 receives one portion of the input light from the optical coupler 206, and the lower arm 210 receives the other portion of the input light from the optical coupler 206. Both arms 208, 210 have an equal effective optical path length, resulting in no effective optical path length difference, thereby resulting in a balanced interferometer. UV trimming, thermal control or voltage control may be applied to one of the arms 208, 210 before the grating to attenuate or switch the dropped wavelength λ₁. Each arm 208, 210 also includes a grating 212, 214, such as a Fiber Bragg grating (FG), each of which have a reflective resonance tuned to reflect a particular wavelength λ₁ and transmit the remaining wavelengths λ₂₋₄ with little or no effect on the remaining wavelengths λ_{2,3,4}, though other gratings or methods of selecting particular wavelengths may be utilized. The gratings 212, 214 may also be disposed on the substrate.

As each portion of input light is incident on the gratings 212, 214, the resonant wavelength λ₁ is reflected back to the optical coupler 206 and coupled through the drop port 204 due to the double 90° (π/2) phase shift. The remaining wavelengths in each portion of the input light are propagated through the arms 208, 210 of the interferometer. The light through the upper arm 208 propagates through a first optical path length and the light through the lower arm 210 propagates through a second optical path length.

The upper arm 208 and the lower arm 210 are optically coupled to an optical coupler 216. The optical coupler 216 is a directional coupler/splitter and may be made from the same materials, process or batch, for example as the optical coupler 206. The optical coupler 216 may also be a 50/50 evanescent coupler or a fused waveguide coupler, and the coupling ratio may vary depending on the wavelength. However, the optical coupler 216 has a wavelength dependence opposite the wavelength dependence of the optical coupler 206. For example, both optical couplers 206, 216 may have a coupling ratio of 50:50 for wavelength λ₁, though the optical coupler 206 may have a coupling ratio of 49:51 for wavelength λ₂ whereas the optical coupler 16 will have a coupling ratio of 51:49 for wavelength λ₂. The transmitted wavelengths λ_{2,3,4} in the upper arm 208 and the lower arm 210 are coupled to the optical coupler 216 with zero phase difference due to the balanced interferometer.

As respectively shown in FIGS. 5 and 6, the first and second optical couplers 206, 216 each have a different coupling length. In the example shown, the second optical coupler 216 has a coupling length, L₂, that is three times as long as the coupling length, L₁, of the first optical coupler 206. As seen in FIG. 5 and referring to the first region wherein light is coupled from one waveguide to another, input light from the input port 202 is partially cross-coupled by the optical coupler 206 to the lower arm 210 in the first coupling region.

By contrast, FIG. 6 shows that the second optical coupler 206 fully couples light from the upper arm 208 to the opposing waveguide and then partially couples the light back again. This may be referred to as over-coupling whereby light is coupled according to the coupling phase or ratio of the second optical coupler 216 in the second coupling region. Light from the lower arm 210 may likewise be coupled by the second optical coupler 216. The light is coupled in the first optical coupler 206 according to a first phase or ratio, and the light is coupled in the second optical coupler 216 according to a second phase or ratio that is opposite the first phase or ratio due to coupling in the second coupling region. For example, the coupling phase in the first optical coupler 206 may be increasing with the wavelength of the light while the coupling phase in the second optical coupler 216 may be decreasing with the wavelength of the light.

Although FIGS. 5 and 6 demonstrate that the optical couplers 206, 216 may have opposite wavelength dependence by a coupling length, L₂, three times longer than the coupling length, L₁, the actual coupling length of the second optical coupler 216 may vary in relation to the optical coupler 206, but still provide an effective coupling length that is three times the effective coupling length of the first optical coupler 206. The effective coupling lengths of each optical coupler 206, 216 may thereby produce coupling according to opposite coupling phases or ratios, and hence opposite wavelength dependence. Although described as having modified the second optical coupler 216, it should be understood that opposite wavelength dependences may be accomplished by providing the first optical coupler 206 with the longer effective coupling length. In addition, opposite wavelength dependence may be accomplished by varying the waveguide width or the waveguide spacing (which decreases exponentially with the coupling coefficient) of the optical couplers 206, 216. For example, the waveguide spacing of the second optical coupler 216 may be one-third of the waveguide spacing of the first optical coupler 206.

Referring again to FIG. 4, the optical coupler 216 is optically coupled to an output port 218 and an add port 220. The optical coupler 216, the output port 218 and the add port 220 may each be provided as waveguides disposed on the substrate. Due to the coupling in the second coupling region of the optical coupler 216, the transmitted wavelengths λ_{2,3,4} undergo a 90° (π/2) phase shift, as in the first optical coupler 206 although according to an opposite coupling phase/ratio. Due to the 90° (π/2) phase shift from cross-coupling in the optical coupler 206, and the 90° (π/2) phase shift from cross-coupling in the optical coupler 216, the transmitted wavelengths λ_{2,3,4} from the lower arm 210 interfere destructively with the transmitted wavelengths λ_{2,3,4} from the upper arm 208 (which undergo no phase shift) at the add port 220. Conversely, there is a no phase difference between the two portions of the transmitted wavelengths λ_{2,3,4} at the output port 218, resulting in constructive interference.

Light of the same wavelength as the dropped wavelength λ₁ is input to the add port 220 and coupled to the optical coupler 216. The optical coupler 216 couples a portion of the added wavelength λ₁ to the upper arm 208 and another portion to the lower arm 210, which is then reflected by the gratings 212, 214 back to the optical coupler 216. The added wavelength λ₁ is transmitted through the output port 218 and combined with the transmitted wavelengths λ_{2,3,4}. Light of the same wavelengths λ₁₋₄ as the input light is thereby transmitted out the output port 218 which corresponds to a cross state port, and the add port 220 corresponds to a bar state port. However, by providing optical couplers 206, 216 with opposing wavelength dependences, any effect, such as band-narrowing, on the wavelengths λ₁₋₄ by the first optical coupler 206 is compensated by the second optical coupler 216. The optical add/drop multiplexer 200 may thereby provide a flat wavelength response in the output.

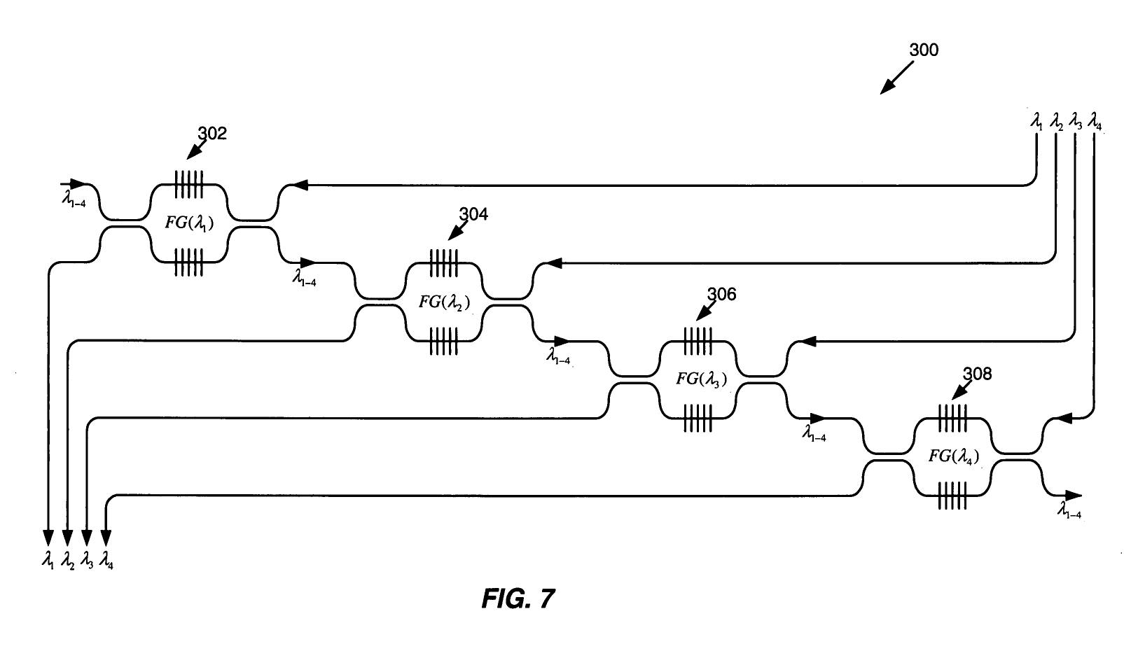

Referring to FIG. 7, a multiple wavelength optical add/drop multiplexer 300 is shown which includes multiple optical add/drop multiplexers 302, 304, 306, 308 as described with respect to FIG. 4. The add/drop multiplexers 302, 304, 306, 308 may be provided on the same substrate, and the multiple wavelength optical add/drop multiplexer 300 may be provided as a planar lightwave circuit. Each add/drop multiplexer 302, 304, 306, 308 may include gratings having different reflective resonances tuned to reflect a different wavelength and transmit the remaining wavelengths with little or no effect on the remaining wavelengths. The output port of each optical add/drop multiplexer 302, 304, 306, 308 may be optically coupled to the input port of the next optical add/drop multiplexer, providing a cascading arrangement of the optical add/drop multiplexers 302, 304, 306, 308.

As with the multiple wavelength add/drop multiplexer 100 described above, each optical add/drop multiplexer 302, 304, 306, 308 may drop a different wavelength, and the multiple wavelength optical add/drop multiplexer 300 may be used to multiplex and demultiplex various wavelengths within a multiplexed optical signal. The number of optical add/drop multiplexers may depend on the number of wavelengths in the input light signal, or on the number of wavelengths to be dropped. Because each optical add/drop multiplexer 302, 304, 306, 308 has optical couplers of opposing wavelength dependences, the multiple wavelength optical add/drop multiplexer 300 may provide an output signal without band-narrowing.

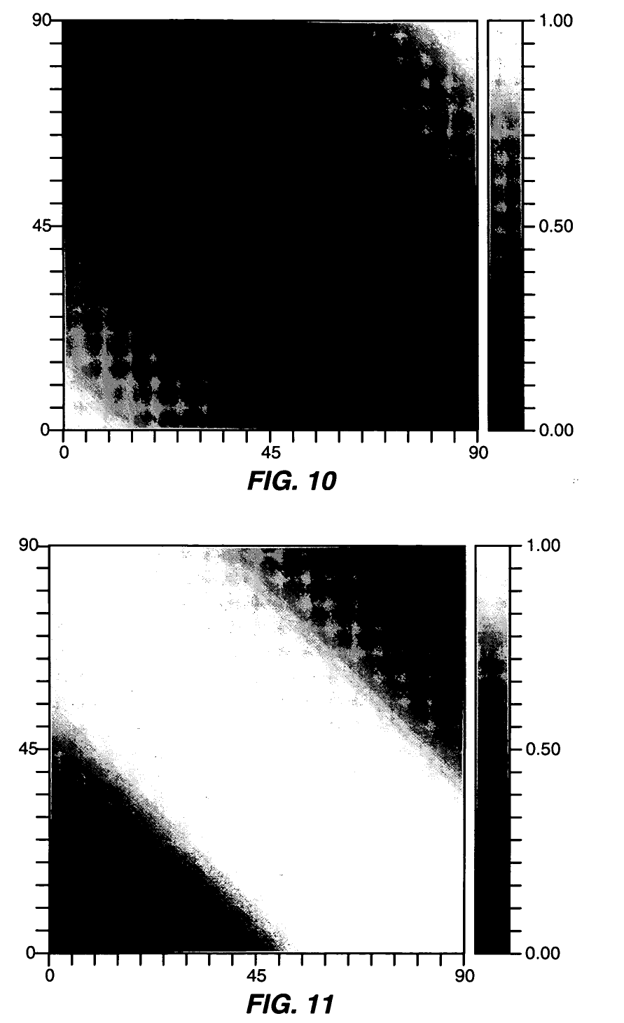

FIGS. 10 and 11 correspond to the output to the bar state (the add port 220) and the output to the cross state (the output port 218), respectively. The Y-axis in each of FIGS. 10 and 11 corresponds to the wavelength dependence of the first optical coupler 206, and the X-axis in each of FIGS. 10 and 11 corresponds to the wavelength dependence of the second optical coupler 216. The wavelength dependence of each optical coupler 206, 216 is shown as the coupling ratio, or coupling phase, of each optical coupler 206, 28. The grayscale of FIGS. 10 and 11 correspond to the intensity of the 206, 216 light being transmitted out the output port 218 and the add port 220, respectively.

As shown in FIG. 10, if the optical couplers 206, 216 have opposite wavelength dependence, all of the light is output through the cross state port (the output port 218). Because the optical couplers 206, 216 are generally manufactured in the same process, they will generally be nominally identical and have the same imperfections. However, by designing the optical couplers 206, 216 as discussed above, the optical couplers 206, 216 may have substantially opposite wavelength dependence. As seen in FIG. 10, the output from the output port 218 remains constant as the coupling phase of the optical couplers 206, 216 remain inversely proportional. Likewise, no light transmitted through the add port 220, as seen in FIG. 11.

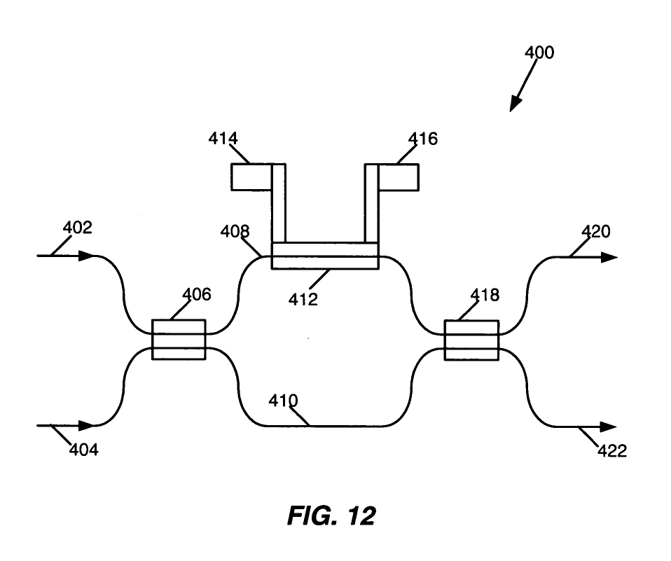

Referring to FIG. 12, an example of a thermo-optic switch 400 is shown. The thermo-optic switch 400 may be built on a substrate as a planar lightwave circuit. The thermo-optic switch 400 is designed from a Mach-Zehnder interferometer and includes a first and second input port 402, 404 and an optical coupler 406 optically coupled to the input port 402, 404. Input light, which may a single or multiple wavelengths λ₁₋₄, is coupled via one or both of the input ports 402, 404 to the optical coupler 406. The optical coupler 406 is a directional coupler/splitter which splits the input light into first and second portions according to its coupling phase or ratio.

An upper arm 408 and a lower arm 410 are optically coupled to the optical coupler 406, and each arm 408, 410 receives a portion of the input light. One of the arms 408, 410 includes a heating element 412, such as a thin film heater, disposed on the arm, which may include disposing the heating element 412 on the waveguide. Utilizing the thermo-optic response of sol-gel materials may also be utilized. The heating element 412 may be coupled to an electrical source via electrical leads 414, 416 which may be operatively coupled to a controller to control the heating element 412. By applying heat to one of the arms 408, 410, the refractive index may be tuned to achieve a particular phase shift in the portion of light being transmitted therein.

The light is transmitted through each arm 408, 410 to an optical coupler 418, including any phase shift applied to one of the light portions based on the heating element 412. The optical coupler 418 is optically coupled to a first output port 420 and a second output port 422. In effect, the thermal-optic switch 400 may be provided as a switch to switch output between the first and second output ports 422. Alternatively, the thermo-optic switch may be provided as a variable optical attenuator, which controllably and gradually varies the output of each output port 420, 422 based on the refractive index tuning provided by the heating element 412.

As with the optical add/drop multiplexers 10, 200 shown in FIGS. 1 and 4, the optical couplers 406, 418 of the thermo-optic switch 400 may have a wavelength dependence that varies the coupling ratio according to the wavelength of the light. The optical couplers 406, 418 may therefore have opposing wavelength dependences, as discussed above, or the upper and lower arms 208, 210 may have an effective optical path length difference of one-half wavelength, as also discussed above.

The output from the output ports 420, 422 may vary depending on the method used to compensate for the wavelength dependence. For example, absent any effects from the heating element 412, input light provided from the input port 402 will provide an output at the output port 422 (corresponding to a cross state port) if the optical couplers 406, 418 have opposing wavelength dependencies, and provide an output at the output port 420 (corresponding to a bar state port) if the lower arm 410 has an effective optical path length difference of one-half wavelength compared to the upper arm 408. It should be understood the output from the output ports 218, 220 may also vary depending on the input port 402, 404 being utilized and on the arm being modified (if applying an effective path length difference of one-half wavelength) based on applicable phase shifts and interference.

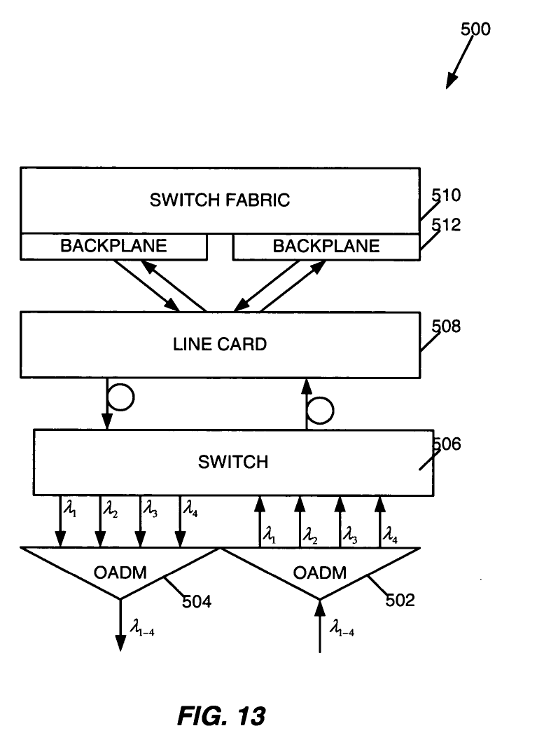

Referring to FIG. 13, an example of an optical system 500 implementing an optical add/drop multiplexer, such as the optical add/drop multiplexer disclosed with respect to FIGS. 1 and 4. The optical add/drop multiplexers may further include cascaded optical add/drop multiplexers for multiplexing and de-multiplexing multiple wavelengths, such as those disclosed with respect to FIGS. 3 and 7. The optical system 500 may further implement a thermo-optic switch, such as the thermo-optic switch disclosed with respect to FIG. 12. The optical system 500 may be utilized in optical communication systems. In one example, the optical system 500 may be provided as a line card, such as a transponder line card, an amplifier line card or an aggregation line card. Alternatively, the optical system 500 may be provided as part of a router, such as an aggregation router or edge router, which may include a line card. The optical system 500 may be utilized in optical communications systems, optical networks or other systems involving optical transmissions. In addition, the optical add/drop multiplexers disclosed above and the thermo-optic switch as disclosed above, may be utilized in various optical systems where multiplexing, de-multiplexing or switching of optical signals is performed.

The optical system 500 includes an optical add/drop multiplexer 502 for receiving a multiplexed optical signal λ₁₋₄. The receiving optical add/drop multiplexer 502 may de-multiplex one or more of the wavelengths from the remaining wavelengths. If de-multiplexing multiple wavelengths, the receiving optical add/drop multiplexer 502 may be a multiple wavelength add/drop multiplexer that includes multiple cascaded optical add/drop multiplexers, each one designed with a grating to separate and drop a particular wavelength from a multiplexed optical signal.

The optical system 500 further includes an optical add/drop multiplexer 504 for transmitting a multiplexed optical signal λ₁₋₄. The transmitting optical add/drop multiplexer 504 may multiplex multiple, disparate wavelengths into a single signal. If multiplexing multiple wavelengths into a multiplexed optical signal λ₁₋₄, the transmitting optical add/drop multiplexer 504 may be a multiple wavelength add/drop multiplexer that includes multiple cascaded optical add/drop multiplexers, each one designed to receive and add an optical signal wavelength and combine it with other optical signal wavelengths.

Although disclosed as separate optical add/drop multiplexers, in one example the optical add/drop multiplexers 502, 504 of the optical system 500 may be provided as the same optical add/drop multiplexer. In such a case, the optical add/drop multiplexer may multiplex optical signals being transmitted by providing the associated signal wavelength through an add port and transmitting the multiplexed signal through an output port. The optical add/drop multiplexer may de-multiplex optical signals being received by receiving the multiplexed signal through the input port and separating the particular signal wavelength via the drop port.

A switch 506 may be optically and operatively coupled to the optical add/drop multiplexers 502, 504. In one example, the switch 506 may include one or more thermo-optic switches to provide an N×N switch. The number of thermo-optic switches may thereby depend on the number of wavelengths being multiplexed and de-multiplexed by the optical add/drop multiplexers 502, 504. The switch 506 may receive an optical signal from the receiving optical add/drop multiplexer 502, and provide a selected optical signal to a line card 508. The optical signal may be selected via control signals arranged to vary the heating element and bias the output of the thermo-optic switch. Likewise, the switch 506 may receive an optical signal from the line card 508, and provide the optical signal to the transmitting optical add/drop multiplexer 504. As above, the optical signal may be selected via control signals which may bias the output of the thermo-optic switch.

The line card 508 may include an electrical-optical (E-O) interface which receives and transmits optical signals, and provides an interface with a physical medium for receiving and transmitting electrical data signals. The particulars of the line card 508 may depend on the application of the line card 508. For example, the line card 508 may be a transponder line card, an aggregation line card or an optical amplifier line card. Although disclosed as separate elements, in one example the optical add/drop multiplexers 502, 504 and the switch 506 may be provided as part of the line card 508. The line card 508 may thereby be used to provide multiplexing, de-multiplexing and switching functions for optical signals.

The line card 508 is coupled to a switch fabric 510 via one or more backplane interfaces 512. The line card 508 may thereby receive optical signals via an optical input from the switch 506 and transmit electrical signals to the switch fabric 510 corresponding to the optical signals. In addition, the line card 508 may receive electrical signals from the switch fabric 510 via the backplane interfaces 512 and transmit optical signals corresponding to the electrical signals to the switch 506 via an optical output.

Although certain apparatus constructed in accordance with the teachings of the invention have been described herein, the scope of the invention is not limited thereto. On the contrary, the invention includes all embodiments of the teachings of the invention fairly falling within the scope of the appended claims either literally or under the doctrine of equivalents.

What is claimed is:

1. An optical circuit having a flat wavelength response comprising:
a first optical coupler arranged to couple input light into a first portion and a second portion;
a first optical waveguide optically coupled to the first optical coupler, the first optical waveguide arranged to receive the first portion of input light from the first optical coupler;
a second optical waveguide optically coupled to the first optical coupler, the second optical waveguide arranged to receive the second portion of input light from the first optical coupler and to effect a fixed phase difference of one-half wavelength relative to the input light;
a second optical coupler optically coupled to the first and second optical waveguides, the second optical coupler arranged to couple the first portion of input light from the first optical waveguide and the second portion of input light from the second optical waveguide.

2. The optical circuit having a flat wavelength response of claim wherein the first optical waveguide is arranged to couple a first portion of output light into the second optical coupler;
wherein the second optical waveguide is arranged to couple a second portion of output light into the second optical coupler, the second portion of output light having a phase difference of one-half wavelength relative to the first portion of output light.

3. The optical circuit having a flat wavelength response of claim 2, wherein the second optical coupler comprises a directional coupler having a first output corresponding to a bar state and a second output corresponding to a cross state, the second optical coupler arranged to constructively couple the first and second portions of output light to the first output and destructively couple the first and second portions of output light to the second output.

4. The optical circuit having a flat wavelength response of claim 1,
wherein the first optical coupler comprises a first wavelength dependence; and
wherein the second optical coupler comprises a second wavelength dependence substantially the same as the first wavelength dependence.

5. The optical circuit having a flat wavelength response of claim 1, wherein the first optical waveguide comprises a variable effective optical path length difference relative to the second optical waveguide.

6. The optical circuit having a flat wavelength response of claim 1, further comprising a heating element arranged to vary the optical path length of one of the following: the first optical waveguide or the second optical waveguide.

7. The optical circuit having a flat wavelength response of claim wherein the first optical waveguide comprises a first optical path length;
wherein the second optical waveguide comprises a second optical path length having an effective path length difference of one-half wavelength relative to the first optical path length.

8. The optical circuit having a flat wavelength response of claim 1, further comprising:
an input port optically coupled to the first optical coupler and optically coupled to a source of the input light, wherein the input light comprises a first wavelength and a second wavelength;
a drop port optically coupled to the first optical coupler;
an output port optically coupled to the second optical coupler, the output port corresponding to a bar state output; and
an add port optically coupled to the second optical coupler, the add port corresponding to a cross state output.

9. The optical circuit having a flat wavelength response of claim 8,
wherein the first optical waveguide is arranged to transmit the first portion of input light of the first wavelength to the second optical coupler and reflect the first portion of input light of the second wavelength to the first optical coupler;
wherein the second optical waveguide is arranged to transmit the second portion of input light of the first wavelength to the second optical coupler and reflect the second portion of input light of the second wavelength to the first optical coupler;
wherein the first optical coupler is arranged to constructively couple the first and second portions of the reflected first wavelength to the drop port and destructively couple the first and second portions of the reflected first wavelength to the input port;
wherein the second optical coupler is arranged to constructively couple the first and second portions of the second wavelength to the output port and destructively couple the first and second portions of the second wavelength to the add port.

10. The optical circuit having a flat wavelength response of claim 8,
wherein the add port is optically coupled to an add light source of the second wavelength;
wherein the second coupler is arranged to couple a first portion of the add light to the first waveguide and couple a second portion of the add light to the second waveguide;
wherein the first optical waveguide is arranged to reflect the first portion of add light to the second optical coupler;
wherein the second optical waveguide is arranged to reflect the second portion of add light to the second optical coupler;
wherein the second optical coupler is arranged to constructively couple the first and second portions of the reflected add light to the bar port and destructively couple the first and second portions of the reflected add light to the cross port.

11. The optical circuit having a flat wavelength response of claim 8, wherein the second optical waveguide is arranged to shift the phase of the second portion of input light of the second wavelength by one-half wavelength.

12. An optical circuit having a flat wavelength response comprising:
a first optical coupler having a first wavelength dependence, the first optical coupler arranged to couple input light into a first portion and a second portion;
a first optical waveguide optically coupled to the first optical coupler, the first optical waveguide arranged to receive the first portion of input light from the first optical coupler;
a second optical waveguide optically coupled to the first optical coupler, the second optical waveguide arranged to receive the second portion of input light from the first optical coupler;
a second optical coupler having a second wavelength dependence opposite the first wavelength dependence, the second optical coupler being optically coupled to the first and second optical waveguides, the second optical coupler arranged to couple the first portion of input light from the first optical waveguide and the second portion of input light from the second optical waveguide.

13. The optical circuit having a flat wavelength response of claim 12, wherein the second optical coupler comprises a directional coupler having a first output corresponding to a bar state and a second output corresponding to cross state, the second optical coupler arranged to destructively couple the first and second portions of input light to the first output and constructively couple the first and second portions of output light to the second output.

14. The optical circuit having a flat wavelength response of claim 12,
wherein the first optical coupler is arranged to couple the input light into the first and second portions of input light according to a first ratio;
wherein the second optical coupler is arranged to couple the first and second portions of input light according to a second ratio opposite the first ratio.

15. The optical circuit having a flat wavelength response of claim 12,
wherein the input light comprises a first wavelength and a second wavelength;
wherein the first optical coupler is arranged to couple the input light of the first wavelength into a first portion and a second portion according to a first ratio;
wherein the first optical coupler is arranged to couple the input light of the second wavelength into a first portion and a second portion according to a second ratio different than the first ratio;
wherein the second optical coupler is arranged to couple the first and second portions of input light of the second wavelength according to a third ratio opposite the second ratio.

16. The optical circuit having a flat wavelength response of claim 12,
wherein the first optical coupler comprises a first coupling length having a first effective optical path length;
wherein the second optical coupler comprises a second coupling length different than the first coupling length and having a second effective optical path length substantially the same as the first effective optical path length.

17. The optical circuit having a flat wavelength response of claim 16, wherein the second coupling length is three times as long as the first coupling length.

18. The optical circuit having a flat wavelength response of claim 12, wherein the first optical waveguide comprises a variable effective optical path length difference relative to the second optical waveguide.

19. The optical circuit having a flat wavelength response of claim 12, further comprising a heating element arranged to vary the optical path length of the first optical waveguide.

20. The optical circuit having a flat wavelength response of claim 12, further comprising:
an input port optically coupled to the first optical coupler and optically coupled to a source of the input light, wherein the input light comprises a first wavelength and a second wavelength;
a drop port optically coupled to the first optical coupler;
an output port optically coupled to the second optical coupler, the output port corresponding to a cross state output; and
an add port optically coupled to the second optical coupler, the add port corresponding to a bar state output.

21. The optical circuit having a flat wavelength response of claim 20,
wherein the first optical waveguide is arranged to transmit the first portion of input light of the first wavelength to the second optical coupler and reflect the first portion of input light of the second wavelength to the first optical coupler;
wherein the second optical waveguide is arranged to transmit the second portion of input light of the first wavelength to the second optical coupler and reflect the second portion of input light of the second wavelength to the first optical coupler;
wherein the first optical coupler is arranged to constructively couple the first and second portions of the reflected first wavelength to the drop port and destructively couple the first and second portions of the reflected first wavelength to the input port;
wherein the second optical coupler is arranged to constructively couple the first and second portions of the second wavelength to the output port and destructively couple the first and second portions of the second wavelength to the add port.

22. The optical circuit having a flat wavelength response of claim 20,
wherein the add port is optically coupled to an add light source of the second wavelength;
wherein the second coupler is arranged to couple a first portion of the add light to the first waveguide and couple a second portion of the add light to the second waveguide;
wherein the first optical waveguide is arranged to reflect the first portion of add light to the second optical coupler;
wherein the second optical waveguide is arranged to reflect the second portion of add light to the second optical coupler;
wherein the second optical coupler is arranged to constructively couple the first and second portions of the reflected add light to the output port and destructively couple the first and second portions of the reflected add light to the add port.

23. A planar lightwave optical add-drop multiplexer comprising:
a substrate layer;
an input waveguide disposed on the substrate layer and optically coupled to an input light source comprising a first wavelength channel and a second wavelength channel;
a drop waveguide disposed on the substrate layer;
an output waveguide disposed on the substrate layer;
an add waveguide disposed on the substrate layer and optically coupled to an input light source comprising the first wavelength channel;
a first optical coupler disposed on the substrate layer and optically coupled to the input waveguide and the drop waveguide;
a second optical coupler disposed on the substrate layer and optically coupled to the output waveguide and the add waveguide;
a first arm waveguide disposed on the substrate layer and optically coupled to the first and second optical couplers, the first arm waveguide having a first grating and first optical path length; and
a second arm waveguide disposed on the substrate layer and optically coupled to the first and second optical couplers, the second arm waveguide having a second grating and a second optical path length having an effective optical path length difference of one-half wavelength relative to the first optical path length.

24. The planar lightwave optical add-drop multiplexer of claim 23,
wherein the first and second gratings each comprise a reflective resonance tuned to reflect the first wavelength channel through the drop waveguide and transmit the second wavelength channel;
wherein the add waveguide corresponds to a cross output;
wherein the drop waveguide corresponds to a bar output.

25. A multiple wavelength optical add/drop multiplexer comprising a plurality of planar lightwave optical add/drop multiplexers of claim 23,
wherein the output waveguide of a first optical add/drop multiplexer is optically coupled to the input waveguide of a second optical add/drop multiplexer;
wherein the first and second gratings of the first optical add/drop multiplexer each have a reflective resonance tuned to reflect the first wavelength channel through the drop waveguide of the first optical add/drop multiplexer and transmit the second wavelength channel;
wherein the first and second gratings of the second optical add/drop multiplexer each have a reflective resonance tuned to reflect the second wavelength channel through the drop waveguide of the second optical add/drop multiplexer and transmit the first wavelength channel.

26. An optical add-drop multiplexer comprising:
a substrate layer;
an input waveguide disposed on the substrate layer and optically coupled to an input light source comprising a first wavelength channel and a second wavelength channel;
a drop waveguide disposed on the substrate layer;
an output waveguide disposed on the substrate layer;
an add waveguide disposed on the substrate layer and optically coupled to an input light source comprising the first wavelength channel;
a first optical coupler disposed on the substrate layer and optically coupled to the input waveguide and the drop waveguide, the first optical coupler comprising a first wavelength dependence;
a second optical coupler disposed on the substrate layer and optically coupled to the output waveguide and the add waveguide, the second optical coupler comprising a second wavelength dependence opposite the first wavelength dependence;
a first arm waveguide disposed on the substrate layer and optically coupled to the first and second optical couplers; and
a second arm waveguide disposed on the substrate layer and optically coupled to the first and second optical couplers.

27. The optical add-drop multiplexer of claim 26,
wherein the first optical coupler comprises a first coupling ratio;
wherein the second optical coupler comprises a second coupling ratio inversely proportional to the first coupling ratio;
wherein the add waveguide corresponds to a bar output;
wherein the drop waveguide corresponds to a cross output.

28. A multiple wavelength optical add/drop multiplexer comprising a plurality of planar lightwave optical add/drop multiplexers of claim 26,
wherein the output waveguide of a first optical add/drop multiplexer is optically coupled to the input waveguide of a second optical add/drop multiplexer;
wherein the first and second gratings of the first optical add/drop multiplexer each have a reflective resonance tuned to reflect the first wavelength channel through the drop waveguide of the first optical add/drop multiplexer and transmit the second wavelength channel;
wherein the first and second gratings of the second optical add/drop multiplexer each have a reflective resonance tuned to reflect the second wavelength channel through the drop waveguide of the second optical add/drop multiplexer and transmit the first wavelength channel.

29. An optical system comprising:
an optical circuit arranged to receive a first optical signal and transmit a second optical signal, the optical component comprising:
a first optical coupler arranged to couple input light into a first portion and a second portion;
a first optical waveguide optically coupled to the first optical coupler, the first optical waveguide arranged to receive the first portion of input light from the first optical coupler;
a second optical waveguide optically coupled to the first optical coupler, the second optical waveguide arranged to receive the second portion of input light from the first optical coupler and to effect a fixed phase difference of one-half wavelength relative to the input light; and
a second optical coupler optically coupled to the first and second optical waveguides, the second optical coupler arranged to couple the first portion of input light from the first optical waveguide and the second portion of input light from the second optical waveguide; and
an electrical-optical interface coupled to the optical circuit, the electrical-optical interface comprising an optical input and an optical output.

30. An optical system of claim 29, wherein the optical circuit comprises an optical add/drop multiplexer, the optical circuit further comprising:
an input waveguide optically coupled to the first optical coupler and optically coupled to a source of the input light comprising a first and second wavelength;
a drop waveguide optically coupled to the first optical coupler;
an add waveguide optically coupled to the second optical coupler;
an output waveguide optically coupled to the second optical coupler;
wherein the first optical waveguide comprises a first grating and the second optical waveguide comprises a second grating, the first and second gratings each comprising a reflective resonance tuned to reflect light of the first wavelength and transmit light of the second wavelength.

31. An optical system of claim 30,
wherein the input light corresponds to the first optical signal;
wherein the first and second gratings are arranged to reflect the first wavelength of the input light through the drop waveguide, the first wavelength of the input light through the drop waveguide corresponding to the second optical signal; and
wherein the optical input of the electrical-optical interface is arranged to receive the second optical signal and output an electrical signal corresponding to the second optical signal.

32. An optical system of claim 30,
wherein the optical output of the electrical-optical interface is arranged to receive an electrical signal corresponding to the first optical signal and transmit the first optical signal, the first optical signal comprising the first wavelength;
wherein the add waveguide is arranged to receive the first optical signal; and
wherein the first and second gratings are arranged to transmit the second wavelength of the input light through the output waveguide and reflect the first wavelength of the first optical signal through the output waveguide, the first and second wavelengths through the output waveguide corresponding to the second optical signal.

33. An optical system of claim 30, wherein the optical circuit comprises a multiple wavelength optical add/drop multiplexer comprising a plurality of the optical add/drop multiplexers,
wherein the output waveguide of a first optical add/drop multiplexer is optically coupled to the input waveguide of a second optical add/drop multiplexer;
wherein the first and second gratings of the first optical add/drop multiplexer each have a reflective resonance tuned to reflect the first wavelength channel through the drop waveguide of the first optical add/drop multiplexer and transmit the second wavelength channel; and
wherein the first and second gratings of the second optical add/drop multiplexer each have a reflective resonance tuned to reflect the second wavelength channel through the drop waveguide of the second optical add/drop multiplexer and transmit the first wavelength channel.

34. An optical system of claim 29, wherein the optical circuit comprises a thermo-optic switch, the optical circuit further comprising a heating element arranged to vary the optical path length of the first optical waveguide.

35. An optical system of claim 29, wherein a line card comprises one or more of the following: the optical circuit or the electrical-optical interface.

36. An optical system comprising:
an optical circuit arranged to receive input light corresponding to a first optical signal and transmit output light corresponding to a second optical signal, the optical component comprising:
a first optical coupler having a first wavelength dependence, the first optical coupler arranged to couple input light into a first portion and a second portion;
a first optical waveguide optically coupled to the first optical coupler, the first optical waveguide arranged to receive the first portion of input light from the first optical coupler;
a second optical waveguide optically coupled to the first optical coupler, the second optical waveguide arranged to receive the second portion of input light from the first optical coupler; and
a second optical coupler having a second wavelength dependence opposite the first wavelength dependence, the second optical coupler being optically coupled to the first and second optical waveguides, the second optical coupler arranged to couple the first portion of input light from the first optical waveguide and the second portion of input light from the second optical waveguide; and
an electrical-optical interface coupled to the optical circuit, the electrical-optical interface comprising an optical input and an optical output.

37. An optical system of claim 36, wherein the optical circuit comprises an optical add/drop multiplexer, the optical circuit further comprising:
an input waveguide optically coupled to the first optical coupler and optically coupled to a source of the input light comprising a first and second wavelength;
a drop waveguide optically coupled to the first optical coupler;
an add waveguide optically coupled to the second optical coupler;
an output waveguide optically coupled to the second optical coupler;
wherein the first optical waveguide comprises a first grating and the second optical waveguide comprises a second grating, the first and second gratings each comprising a reflective resonance tuned to reflect light of the first wavelength and transmit light of the second wavelength.

38. An optical system of claim 37,
wherein the input light corresponds to the first optical signal;
wherein the first and second gratings are arranged to reflect the first wavelength of the input light through the drop waveguide, the first wavelength of the input light through the drop waveguide corresponding to the second optical signal; and
wherein the optical input of the electrical-optical interface is arranged to receive the second optical signal and output an electrical signal corresponding to the second optical signal.

39. An optical system of claim 37,
wherein the optical output of the electrical-optical interface is arranged to receive an electrical signal corresponding to the first optical signal and transmit the first optical signal, the first optical signal comprising the first wavelength;
wherein the add waveguide is arranged to receive the first optical signal; and
wherein the first and second gratings are arranged to transmit the second wavelength of the input light through the output waveguide and reflect the first wavelength of the first optical signal through the output waveguide, the first and second wavelengths through the output waveguide corresponding to the second optical signal.

40. An optical system of claim 37, wherein the optical circuit comprises a multiple wavelength optical add/drop multiplexer comprising a plurality of the optical add/drop multiplexers,
wherein the output waveguide of a first optical add/drop multiplexer is optically coupled to the input waveguide of a second optical add/drop multiplexer;
wherein the first and second gratings of the first optical add/drop multiplexer each have a reflective resonance tuned to reflect the first wavelength channel through the drop waveguide of the first optical add/drop multiplexer and transmit the second wavelength channel; and
wherein the first and second gratings of the second optical add/drop multiplexer each have a reflective resonance tuned to reflect the second wavelength channel through the drop waveguide of the second optical add/drop multiplexer and transmit the first wavelength channel.

41. An optical system of claim 36, wherein the optical circuit comprises a thermo-optic switch, the optical circuit further comprising a heating element arranged to vary the optical path length of the first optical waveguide.

42. An optical system of claim 36, wherein a line card comprises one or more of the following: the optical circuit or the electrical-optical interface.
